(19) United States
(12) Patent Application Publication
(10) Pub. No.: US 2024/0403651 A1
(43) Pub. Date: Dec. 5, 2024

(54) TRAJECTORY-BASED EXPLAINABILITY FRAMEWORK FOR REINFORCEMENT LEARNING MODELS

(71) Applicant: Adobe Inc., San Jose, CA (US)

(72) Inventors: Shripad Vilasrao Deshmukh, Solapur (IN); Arpan Dasgupta, Kolkata (IN); Balaji Krishnamurthy, Noida (IN); Chirag Agarwal, Noida (IN); Georgios Theocharous, San Jose, CA (US); Jayakumar Subramanian, Mumbai (IN)

(21) Appl. No.: 18/328,174

(22) Filed: Jun. 2, 2023

(51) Int. Cl. G06N 3/092

(52) U.S. Cl. CPC G06N 3/092

(57) ABSTRACT

The present disclosure relates to systems, methods, and non-transitory computer readable media that provide a trajectory-based explainability framework for reinforcement learning models. For example, the disclosed systems generate trajectory clusters from trajectories utilized to train a reinforcement learning agent. In some embodiments, the disclosed system generates a complementary target data set by removing a target trajectory cluster from the trajectory clusters. In some cases, the disclosed system trains a test reinforcement learning agent utilizing the complementary target data set and generates a cluster attribution by comparing the result of the test reinforcement learning agent with the result of the reinforcement learning agent.

### BACKGROUND

Recent years have seen significant advancements in artificial intelligence and machine-learning models that utilize computing devices to observe and interpret different environments. Indeed, many systems utilize computer-implemented reinforcement learning models to make decisions based on learned policies to optimize results. For example, some systems utilize offline reinforcement learning agents that are trained on historically collected data. Despite these advancements, due to the black box nature of reinforcement learning agents, it is difficult to understand which factors influence the reinforcement learning model.

### SUMMARY

This disclosure describes one or more embodiments of methods, non-transitory computer readable media, and systems that solve the foregoing problems (in addition to providing other benefits) utilizing a trajectory-based explainability framework for reinforcement learning models. In particular, in one or more implementations, the disclosed systems generate attributions for policy decisions of a trained reinforcement learning agent based on the trajectories encountered by the reinforcement learning model during training. To illustrate, the disclosed systems encode trajectories in offline training data individually as well as collectively. The disclosed systems then attribute policy decisions to a set of trajectories in this encoded space by estimating the sensitivity of the decision with respect to that set.

For example, the disclosed system groups (e.g., clusters) together certain trajectories into trajectory clusters. Subsequently, the disclosed system removes a trajectory cluster from the collection of encoded trajectories and trains a test reinforcement agent on the modified collection of encoded trajectories. The disclosed system then compares the results of the reinforcement agent and test reinforcement agent to see if the trajectories in the cluster influenced the reinforcement learning agent (i.e., led to a different decision). Based on the comparison, the disclosed system identifies (e.g., attributes) trajectories responsible for the decision of the reinforcement learning agent. Thus, the disclosed system provides an accurate and flexible framework for attributing the trajectories that influence the behavior of a reinforcement learning agent.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a trajectory attribution system operates in accordance with one or more embodiments.

FIG. 2 illustrates an overview diagram of the trajectory attribution system generating a cluster attribution for a target trajectory cluster in accordance with one or more embodiments.

FIGS. 3A-3B illustrate the trajectory attribution system generating a cluster attribution in accordance with one or more embodiments.

FIGS. 4A-4B illustrate examples of the trajectory attribution system suggesting an action and attributing the decision to trajectories in accordance with one or more embodiments.

FIG. 5 illustrates an example schematic diagram of a trajectory attribution system in accordance with one or more embodiments.

FIG. 6 illustrates a flowchart of a series of acts for generating a cluster attribution in accordance with one or more embodiments.

FIG. 7 illustrates a block diagram of an exemplary computing device in accordance with one or more embodiments.

### DETAILED DESCRIPTION

One or more embodiments described herein include a trajectory attribution system that identifies trajectories that lead a reinforcement learning model to generate certain selections. In particular, the trajectory attribution system identifies a set of trajectories, the absence of which from the training data leads to different behavior at the state under consideration. To illustrate, the trajectory attribution system groups trajectories into clusters which can then be used to analyze their role in the decision-making of the reinforcement learning model. In particular, the trajectory attribution system clusters the trajectories using trajectory embeddings produced utilizing sequence modelling approaches.

To illustrate, in one or more embodiment, the trajectory attribution system trains a reinforcement learning agent on a complete offline data set. For example, the complete offline data set includes an entire sequence of encoded trajectories and the trajectory attribution system trains a reinforcement learning agent on the entire sequence of encoded trajectories. In particular, the trajectory attribution system generates original results based on the entire sequence of encoded trajectories. In one or more implementations, the trajectory attribution system groups (e.g., clusters) the encoded trajectories together into trajectory clusters and generates a complementary target data set for a target trajectory cluster by removing the target trajectory cluster from the collection of trajectory clusters. In certain implementations, the trajectory attribution system trains a test reinforcement learning agent with the complementary target data set. In one or more implementations, the trajectory attribution system compares the results of the test reinforcement learning agent with the original results of the reinforcement learning agent. In some cases, based on the comparison, the trajectory attribution system generates a cluster attribution for the target cluster and its corresponding trajectories.

As indicated above, in some embodiments, the trajectory attribution system generates trajectory clusters from the trajectories utilized to train the reinforcement learning agent. In particular implementations, the trajectory attribution system utilizes a clustering algorithm to cluster certain trajectories together.

In addition to generating trajectory clusters, in one or more cases, the trajectory attribution system generates a complementary target data set by removing a target trajectory cluster from the set of trajectory clusters. For example, the trajectory attribution system removes the target trajectory cluster from the original offline data set. For instance, the complementary target data set includes the entirety of the original offline data set except for the trajectories contained in the target trajectory cluster. Additionally, in one or more embodiments, the trajectory attribution system generates a complementary data set for each trajectory cluster.

As mentioned above, in certain embodiments, the trajectory attribution system trains a test reinforcement learning agent with the complementary target data set. To illustrate, the trajectory attribution system trains the test reinforcement learning agent on all of the trajectory clusters except the target trajectory cluster. In some cases, the result of the test reinforcement learning agent differs from the result of the reinforcement learning agent.

As previously indicated, the trajectory attribution system generates a cluster attribution by comparing the results of the test reinforcement learning agent with the results of the reinforcement learning agent. In particular, the trajectory attribution system determines if the result of the test reinforcement learning agent differs from the result of the reinforcement learning agent. In some embodiments, based on the comparison, the trajectory attribution system attributes the actions of the reinforcement learning agent to the target cluster.

Existing approaches suffer from several technological shortcomings that result in inaccurate and inflexible operation of computing systems in interpreting behaviors of reinforcement learning models. For instance, some existing approaches distill reinforcement learning agent behaviors into simpler models (e.g., decision trees) or into human understandable high-level decision language so that it is easier to follow the behaviors of the reinforcement learning agent. However, such policy simplification approaches lose information contained in the original policy leading to a poor approximation of the behavior of complex reinforcement learning models.

In addition to inaccuracy, existing methods are also operationally inflexible. For instance, some existing systems utilize feature saliency methods to describe the behaviors of reinforcement learning agents by utilizing feature gradients. However, some existing feature gradients methods are limited. To illustrate, certain gradient-based methods require full access to the parameters of the reinforcement learning agent. However, some reinforcement learning models have strict security protocols limiting access to certain parameters (e.g., model weights) of the reinforcement learning agent. Moreover, some current systems explain the behavior of a reinforcement learning agent by utilizing causality-based approaches. However, causality-based techniques require direct access to the environment or a highly accurate (e.g., high fidelity) model of the reinforcement learning environment. The scarcity of trajectory data to generate high-fidelity models and impracticality of interacting with the environment makes causality-based approaches inflexible.

In addition, some existing methods are inefficient. For example, some current methods utilize state perturbation methods to generate local explanations of reinforcement learning agents. However, state perturbation methods, require their perturbation strategies to be tailored to a given environment. Not only is this approach inflexible, but it is also inefficient because it requires cumbersome environmental design and validation which utilizes excessive amounts of computer resources. These along with additional problems and issues exist with regard to explaining the behaviors and actions of reinforcement learning agents.

As suggested above, the trajectory attribution system provides several improvements and/or advantages over conventional explainable reinforcement learning approaches. For instance, unlike existing systems, the trajectory attribution system can operate in diverse environments. To illustrate, in one or more implementations, the trajectory attribution system can work in continuous and discrete state-action spaces. For instance, grouping the trajectories into trajectory clusters and using those trajectory clusters to analyze their role in the behavior of the reinforcement learning agent makes it computationally feasible to analyze the behaviors of reinforcement learning agents in large, continuous state-action spaces. Moreover, the trajectory attribution system works in continuous and discrete state-action spaces without significantly modifying the algorithms as described in more detail below.

Additionally, the disclosed trajectory attribution system improves the accuracy explainable reinforcement learning agents. For instance, the novel approach of one or more implementations of the trajectory attribution system enables the usage of rich latent representations. For example, unlike existing systems that lose information by distilling reinforcement learning agent policies into simpler models, in certain embodiments, the trajectory attribution system produces highly insightful and easily understandable attributions that utilize the information related to the policies of the reinforcement learning agent. In particular, the trajectory attribution system utilizes a first of its kind method of encoding a collection of trajectories into a single data encoding. This new encoding method allows the trajectory attribution system to compare different collections of trajectories. In particular, the trajectory attribution system utilizes a novel technique for computing distances between difference collections of trajectories. Thus, the novel data encoding method allows the trajectory attribution system to explain, in terms of high-level behavior, the actions of the reinforcement learning agent.

Moreover, the disclosed trajectory attribution system improves the efficiency of existing systems. As discussed above, existing systems require direct access to the environment or highly accurate depictions of the environment. Unlike existing systems, the disclosed trajectory attribution system utilizes historic data (e.g., trajectories encountered by the reinforcement learning agent in the past) to explain the factors that lead to the behavior of the reinforcement learning agent. Thus, the trajectory attribution system does not require elaborate environmental design or validation.

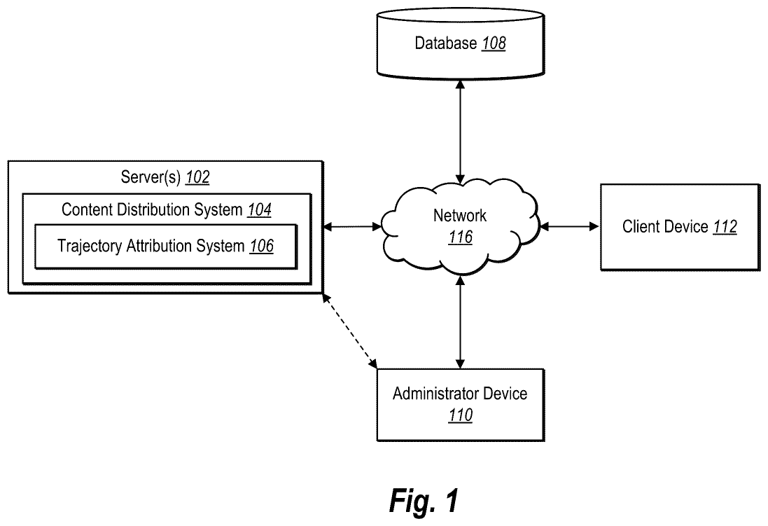

Additional detail regarding the trajectory attribution system will now be provided with reference to the figures. For example, FIG. 1 illustrates a schematic diagram of an example system environment for implementing a trajectory attribution system 106 in accordance with one or more embodiments. An overview of the trajectory attribution system 106 is described in relation to FIG. 1. Thereafter, a more detailed description of the components and processes of the trajectory attribution system 106 is provided in relation to the subsequent figures.

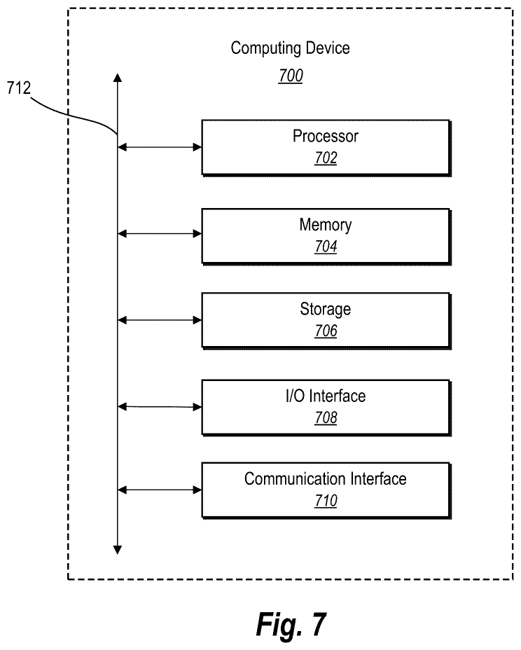

As shown, the system environment includes a server(s) 102, a content distribution system 104, a database 108, an administrator device 110, a client device 112, and a network 116. Each of the components of the environment communicate via the network 116, and the network 116 is any suitable network over which computing devices communicate. Example networks are discussed in more detail below in relation to FIG. 7.

As mentioned, the system environment includes a client device 112. The client device 112 is one of a variety of computing devices, including a smartphone, a tablet, a smart television, a desktop computer, a laptop computer, a virtual reality device, an augmented reality device, or another computing device as described in relation to FIG. 7. The client device 112 communicates with the server(s) 102, the database 108, and/or the administrator device 110 via the network 116. For example, the client device 112 provides information to the server(s) 102 indicating client device interactions and/or engagement within an environment (e.g., interactions with digital content). For instance, digital content includes video, audio, images, and/or text in a digital format. To illustrate, digital content includes websites, emails, online games, streaming video, animations, etc. In particular embodiments, the client device interactions with the digital content provided by the client device 112 becomes historically collected data.

Indeed, as illustrated in FIG. 1, the system environment includes a database 108. In one or more embodiments, the database 108 is located external to the server(s) 102 (e.g., in communication via the network 116) or located on the server(s) 102 and/or on the client device 112. Moreover, the database 108 can store digital content and/or historical data related to various client device interactions or other environments. For example, the database 108 stores trajectories (e.g., collected experiences, sequences, etc.), complementary data sets, explanation policies, algorithms, encodings, embeddings, etc.

As illustrated in FIG. 1, the system environment includes the administrator device 110. In some embodiments, the administrator device 110 is external to the server(s) 102, the database 108, and/or the client device 112. In some cases, the administrator device 110 manages, distributes, and/or supervises digital content associated with one or more environments. For example, in some cases, the administrator device 110 distributes a marketing campaign to a client device 112 to gain data based on the client device interactions with the marketing campaign. In other embodiments, the administrator device 110, distributes a marketing campaign based on previous decisions of the reinforcement learning agent. In certain embodiments, the server(s) 102 and/or database 108 access the historical data from various environments managed by the administrator device 110. In certain cases, the administrator device 110 includes all or part of the trajectory attribution system 106.

As illustrated in FIG. 1, the system environment includes the server(s) 102. The server(s) 102 generates, tracks, stores, processes, receives, and transmits electronic data. For example, the server(s) 102 receives data from the client device 112 in the form of interactions with digital content (e.g., websites, e-mails, online games, e-commerce pages). In one or more embodiments, the server(s) 102 stores trajectories (e.g., collected experiences, sequences, etc.), complementary data sets, explanation policies, algorithms, encodings, embeddings, etc.

In some embodiments, the server(s) 102 communicates with the client device 112, the database 108, and/or administrator device 110 to transmit and/or receive data via the network 116, including client device interactions historical data, trajectories, and/or other data. In some embodiments, the server(s) 102 comprises a distributed server where the server(s) 102 includes a number of server devices distributed across the network 116 and located in different physical locations. The server(s) 102 comprise a content server, an application server, a communication server, a web-hosting server, a multidimensional server, a container orchestration server, or a machine learning server. The server(s) 102 further access and utilize a database 108 to store and retrieve information such as environmental data, predictive data, and/or historical data.

As further shown in FIG. 1, the server(s) 102 also includes the trajectory attribution system 106 as part of a content distribution system 104. For example, in one or more implementations, the content distribution system 104 is able to track, store, manage, supervise, provide, distribute, and/or share digital content. In one or more embodiments, the server(s) 102 includes all, or a portion of, the trajectory attribution system 106. For example, the trajectory attribution system 106 operates on the server(s) 102 to generate a cluster attribution for the reinforcement learning agent by comparing results of the reinforcement learning agent and the test reinforcement learning agent.

In certain cases, the client device 112 includes all or part of the trajectory attribution system 106. For example, the client device 112 generates, obtains (e.g., downloads), or utilizes one or more aspects of the trajectory attribution system 106 from the server(s) 102. Indeed, in some implementations, as illustrated in FIG. 1, the trajectory attribution system 106 is located in whole or in part on the client device 112. For example, the trajectory attribution system 106 includes a web hosting application that allows the client device 112 to interact with the server(s) 102. To illustrate, in one or more implementations, the client device 112 accesses a web page supported and/or hosted by the server(s) 102.

In one or more embodiments, the client device 112 and the server(s) 102 work together to implement the trajectory attribution system 106. For example, in some embodiments, the server(s) 102 train one or more machine learning models (e.g., reinforcement learning models) discussed herein and provide the one or more machine learning models to the client device 112 for implementation. In some embodiments, the server(s) 102 trains one or more machine learning models together with the client device 112.

Although FIG. 1 illustrates a particular arrangement of the system environment, in some embodiments, the system environment has a different arrangement of components and/or may have a different number or set of components altogether. For instance, as mentioned, the trajectory attribution system 106 is implemented by (e.g., located entirely or in part on) the client device 112 or the administrator device 110. In addition, in one or more embodiments, the client device 112 communicates directly with the trajectory attribution system 106, bypassing the network 116. Further, in some embodiments, the database 108 is maintained and/or housed by the server(s) 102, the administrator device 110, or a third-party device.

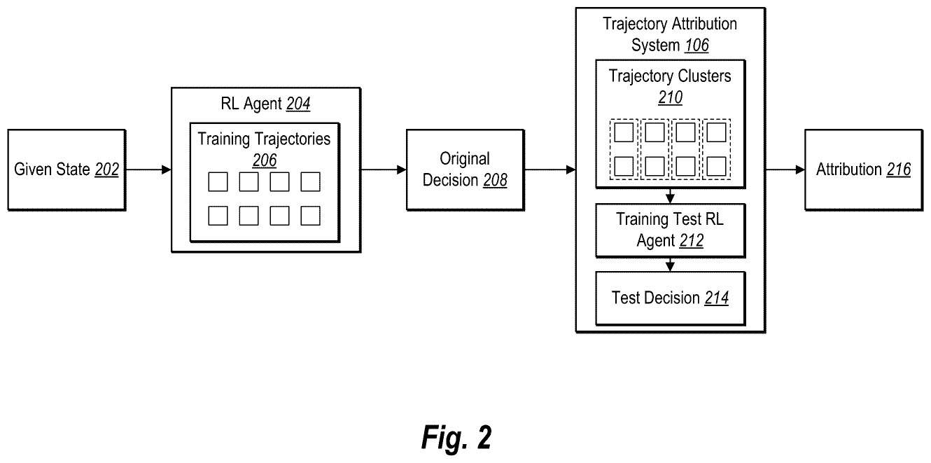

As mentioned above, in one or more embodiments, the trajectory attribution system 106 generates a cluster attribution for a reinforcement learning agent. For example, the trajectory attribution system 106 generates the cluster attribution by comparing a result of the test reinforcement learning agent and a result of the reinforcement learning agent. FIG. 2 illustrates an example overview of the trajectory attribution system 106 attributing an action chosen by the reinforcement learning agent at a given state to a cluster of trajectories (e.g., trajectory cluster) in accordance with one or more embodiments. The description of FIG. 2 provides an overview of various acts and processes associated with the trajectory attribution system 106, and additional detail regarding the various acts illustrated in FIG. 2 is provided thereafter with reference to subsequent figures.

FIG. 2 illustrates a given state 202 for an environment. In particular, the given state 202 corresponds to given conditions, contexts, or factors associated with an environment. To illustrate an environment can include a video game, strategic game, advertisement campaign, customer management service, etc. For example, in a grid environment with an objective to move to a particular cell, the given state 202 includes a current cell (e.g., (1,1)) within the grid.

FIG. 2 further illustrates a reinforcement learning agent 204 training on a set of training trajectories 206 for the given state 202. As used herein the term “reinforcement learning agent” refers to all or part of a reinforcement learning model that takes actions and/or makes decisions based on a learned policy. A reinforcement learning model includes a machine learning model that learns to take actions in an environment in order to improve (maximize) a particular reward. In one or more cases, the reinforcement learning agent learns policies by training on different data sets. In particular a reinforcement learning agent is trained to learn a policy that maximizes a reward function (or other reinforcement signal) given a set of states, a set of actions, and probabilities of transitioning to different states given a particular action. For example, the trajectory attribution system 106 can train the reinforcement learning agent on a set of trajectories. In one or more embodiments, the reinforcement learning agent 204 is offline and does not have direct access to the environment of the given state 202. In some implementations the reinforcement learning agent is a natural language processing tool, a language model utilizing artificial intelligence (e.g., ChatGPT), a Deep Q-Network (DQN) agent, a Soft Actor-Critic (SAC) agent, a Deep Deterministic Policy Gradient (DDPG) agents, and/or model trained on reinforcement learning algorithms.

In particular, FIG. 2 shows the reinforcement learning agent 204 training on a historic (e.g., offline) data set comprising the set of training trajectories 206. In some implementations, the historic data set includes any number and/or amount of training trajectories 206. For instance, in one or more embodiments, the set of training trajectories 206 ranges from 500 trajectories to 1,000,000 trajectories. In some implementations, the set of training trajectories 206 comprises 1,000 trajectories. In certain cases, the reinforcement learning agent 204 trains on the set of training trajectories 206 by utilizing an offline reinforcement learning algorithm.

As further shown in FIG. 2, the reinforcement learning agent 204 makes an original decision 208 (e.g., reinforcement learning decision). In particular, based on the entire set of training trajectories 206, the reinforcement learning agent 204 makes the original decision 208 for the given state 202. In some embodiments, the reinforcement learning agent 204 utilizes a learned policy to make the original decision 208 (e.g., the action chosen by the policy).

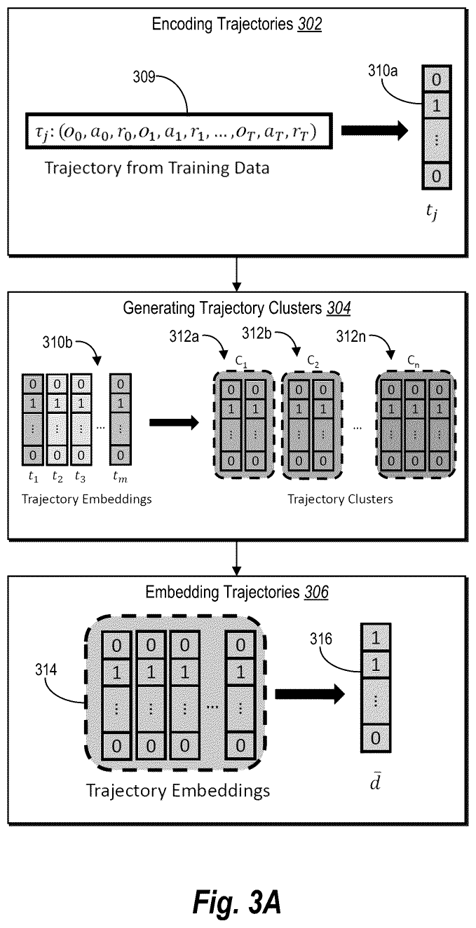

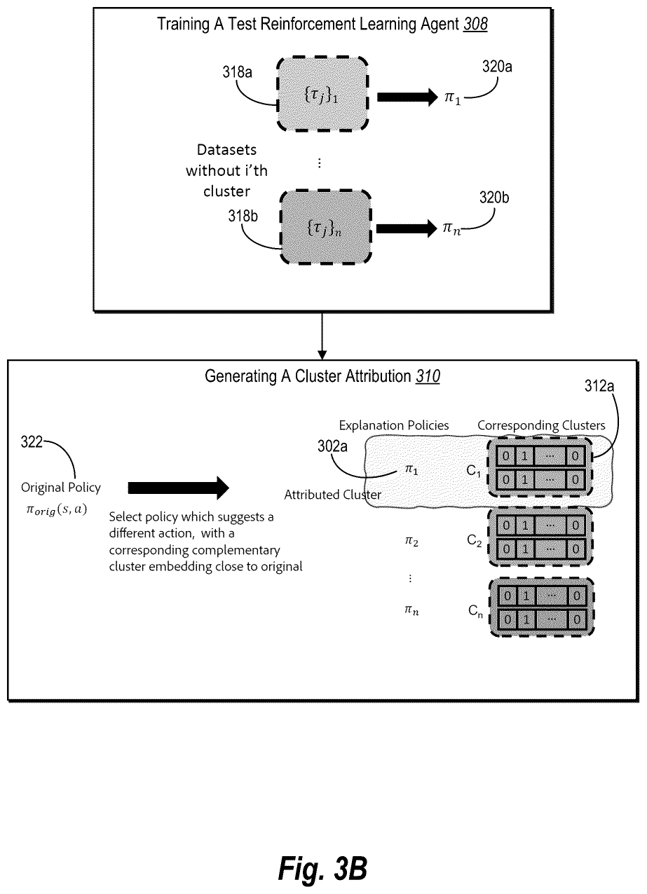

As FIG. 2 illustrates, once the trajectory attribution system 106 generates the original decision 208 utilizing the reinforcement learning agent 204, the trajectory attribution system 106 groups the training trajectories 206 into trajectory clusters 210. In particular, the trajectory clusters 210 represent groups of training trajectories 206. In some embodiments, the trajectory attribution system 106 groups the training trajectories 206 into trajectory clusters 210 by utilizing a clustering algorithm. Additional detail regarding generating trajectory clusters is provided below (e.g., in relation to FIG. 3A).

In some cases, once the trajectory attribution system 106 generates the trajectory clusters, the trajectory attribution system 106 generates complementary data sets. In particular, the trajectory attribution system 106 generates a complementary data set for each trajectory cluster. To illustrate, in some implementations, the trajectory attribution system 106 generates a complementary target data set by removing the target trajectory cluster from the trajectory clusters 210. Thus, in certain cases, the complementary target data set includes all of the training trajectories 206 except for the trajectories in the target trajectory cluster. Additional detail regarding complementary datasets is provided below (e.g., in relation to FIG. 3B).

As just mentioned, the trajectory attribution system 106 generates a complementary data set for each trajectory cluster. FIG. 2 further shows, the trajectory attribution system 106 trains a test reinforcement learning agent 212 on the complementary data sets. As used herein, the term “test reinforcement learning agent” refers to a reinforcement learning agent trained on complementary/test data sets. In some embodiments, the parameters of the test reinforcement learning agent mirror the parameters of the reinforcement learning agent 204. In one or more cases, the test reinforcement learning agent makes a decision that differs from the reinforcement learning agent. As FIG. 2 shows, the test reinforcement learning agent generates a test decision 214 based on training the test reinforcement learning agent on the complementary data set. In certain implementations, the parameters of the test reinforcement learning agent 212 are identical to the parameters of the reinforcement learning agent 204. In some cases, based on the complementary data set used to train the test reinforcement learning agent 212 the test decision 214 is the same as the original decision 208 or differs from the original decision 208. Additional detail regarding training test reinforcement learning agents is provided below (e.g., relation to FIG. 3B).

As shown in FIG. 2, the trajectory attribution system 106 determines an attribution 216 for the trajectory cluster. In particular, the trajectory attribution system 106 compares the original decision 208 against the test decision 214 associated with the complementary data set. Based on the comparison, the trajectory attribution system 106 generates a cluster attribution for the trajectory cluster. For example, the trajectory attribution system 106 generates the cluster attribution for the target cluster by comparing the results of the test reinforcement learning agent training on the complementary target data set with the original results of the reinforcement learning agent. Additional detail regarding determining a cluster attribution for a reinforcement learning agent is provided below (e.g., in relation to FIG. 3B).

In some embodiments, the trajectory attribution system 106 provides a query feature, where the most relevant data entries (e.g., trajectories) may be found. In particular, the trajectory attribution system 106 can receive a query from a client device regarding a particular decision of a reinforcement learning agent. In response, the trajectory attribution system 106 determines a cluster attribution and provides an indication of the cluster attribution for display.

As discussed above, the trajectory attribution system 106 attributes the actions of a reinforcement learning agent by comparing the result of the reinforcement learning agent trained on the original offline data set and the result of the test reinforcement learning agent trained on a modified data set (e.g., complementary data set). FIGS. 3A-3B show the trajectory attribution system 106 generating the cluster attribution for a target cluster in accordance with one or more embodiments.

More specifically, FIG. 3A depicts a sequence of acts for encoding the trajectories, generating the trajectory clusters, and embedding the trajectories into a single embedding. As previously discussed, the trajectory attribution system 106 attributes a cluster of trajectories to a policy (e.g., decision/result) of the reinforcement learning agent for a particular state.

As shown in FIG. 3A, the trajectory attribution system 106 performs the act 302 of encoding the trajectories 309. In particular, the trajectory attribution system 106 encodes, from an offline reinforcement learning data set, the trajectories 309 individually. As used herein a “trajectory” refers to a past experience and/or sequence within a given environment. For example, the reinforcement learning agent can learn certain behaviors based on encountering certain trajectories (e.g., collected experiences, sequences, etc.). In some embodiments, the trajectory comprises an observation, an action, and reward for a given state in the given environment. For example, in a grid-world environment a trajectory can include (i) an observation about the location (e.g., cell) of the reinforcement learning agent, (ii) an action where the reinforcement learning agent decides to move to up, down, left, or right to another location (e.g., cell), and (iii) a reward where the reinforcement learning agent receives a benefit for making a desired decision.

As indicated above, the trajectory attribution system 106 encodes the trajectories 309 from the offline data set (e.g., offline reinforcement learning data set). In some embodiments, the trajectory attribution system 106 encodes the trajectories 309 individually. In particular, the trajectory attribution system 106 encodes the trajectories 309 by generating an output token for each observation, action, and reward in the trajectories 309. In some cases, the trajectory attribution system 106 generates the output tokens by inputting the trajectories 309 into a sequence encoder. For example, the trajectory attribution system 106 may generate output tokens for all observations, actions, and per-step rewards in the trajectories 309 included in the offline data set.

In certain cases, the trajectory attribution system 106 generates trajectory embeddings 310a-310b by taking the average of the output tokens. For example, the trajectory attribution system 106 can divide the output tokens by the number of input tokens. As described in more detail below, the trajectory attribution system 106 can group the trajectory embeddings 310a-310b into trajectory clusters.

As described above, the trajectory attribution system 106 can encode trajectories 309 from the offline data set. In some embodiments, the offline reinforcement learning data set (D) comprises a set of (nᵣ) trajectories. In certain implementations, the trajectory attribution system 106 determines the trajectory by identifying an observed state, an action corresponding to the observed state, and a reward upon pursing the action. Thus, in some cases, each trajectory, denoted by (τⱼ) includes a sequence of observation (oₖ), action (aₖ) and per-step reward (rₖ) tuples with k ranging from 1 to the length of the trajectory (τⱼ). In one or more embodiments, the trajectory attribution system 106 tokenizes the trajectories 309 from the offline reinforcement learning data set (D) to align with the specifications of a sequence encoder (E). For instance, in certain embodiments, the sequence encoder is a decision transformer and corresponds to certain specifications. In alternative implementations, the sequence encoder is a trajectory transformer and corresponds to one or more specifications.

As mentioned above, the trajectory attribution system 106 encodes the trajectories 309 from the offline reinforcement learning data set (D). In some embodiments, the trajectory attribution system 106 generates trajectory representations by encoding the trajectories 309. In one or more embodiments, the trajectory attribution system 106 encodes a given set of trajectories individually according to the following algorithm (e.g., Algorithm 1):

Algorithm 1: encode Trajectories

| | |
|---|---|
| /* Encoding given set of trajectories individually | */ |

| | |
|---|---|
| Input | : Offline Data {τᵢ}, Sequence Encoder E |
| Initialize | : Initialize array T to collect the trajectory embeddings |

1 for τⱼ in {τᵢ} do

| | /* | Using E, get output tokens for all the o, a & r in τⱼ | */ |
|---|---|---|---|
| 2 | (eₒ_{_{1,j}},eₐ_{_{1,j}},eᵣ_{_{1,j...}},eₐ [symbol] ,_{ⱼ},eᵣ [symbol] ,_{ⱼ}) ← E(o_{1,j} a_{1,j} r_{1,j} ... , [symbol] ,ⱼ, [symbol] ,ⱼ [symbol] ,ⱼ) // where | | |
| | 3 [symbol] = #input tokens | | |
| | /* | Take mean of outputs to generate τⱼ's embedding τⱼ | */ |

| | |
|---|---|
| 3 | tⱼ ← (eₒ_{_{1,j}} + eₐ_{_{1,j}} + eᵣ_{_{1,j}} + eₒ_{_{2,j}} + eₐ_{_{2,j}} + ... + eₒ [symbol] ,_{ⱼ} + eₐ [symbol] ,_{ⱼ} + |
| | e [symbol] )/(3 [symbol] ) |
| 4 | Append tⱼ to T |
| Output | : Return the trajectory embeddings T = {t;} |

where {τᵢ} represents the trajectories in the offline data set, E represents the sequence encoder, T represents the trajectory embeddings, o represents the observation, a represents the action and r represents the per-step reward, e represents the output tokens, τⱼ represents individual trajectory embeddings, tⱼ represents the trajectory embedding as an average of the output tokens, and T={tᵢ} represents the returned trajectory embeddings.

As shown in FIG. 3A and in the above Algorithm 1, the trajectory attribution system 106 feeds the observation (oₖ), action (aₖ) and per-step reward (rₖ) tokens into the sequence encoder (E). In certain cases, the sequence encoder produces output tokens ( [symbol] ) which correspond to latent representations. As mentioned above, in one or more embodiments, the trajectory attribution system 106 defines trajectory embeddings 310a (tⱼ) as an average of the output tokens ( [symbol] ).

As further shown in FIG. 3A, the trajectory attribution system 106 performs the act 304 of generating trajectory clusters. In particular, the trajectory attribution system 106 can find the smallest set of trajectories 309, the absence of which from the offline reinforcement learning training data leads to a different behavior for the given state under consideration. To illustrate, the trajectory attribution system 106 can group the trajectories into trajectory clusters 312a-312n. In some embodiments, the trajectory attribution system 106 clusters the trajectory embeddings 310a-310b by utilizing a clustering algorithm. As used herein, the term “clustering algorithm” refers to an algorithm that groups trajectories into trajectory clusters. In particular, the clustering algorithm is able to find patterns among the trajectories. In some cases, the clustering algorithm is an X-means or K-means clustering algorithm. In one or more embodiments, the cluster algorithm is a DBSCAN, mean shift, mixture of gaussians, etc. algorithm.

As just mentioned, in one or more embodiments, the trajectory attribution system 106 groups trajectories 309 into trajectory clusters 312a-312n by utilizing the clustering algorithm. In some instances, the number of trajectory clusters 312a-312n and number of trajectory embeddings 310a-310b within the trajectory clusters 312a-312n vary based on the environment and/or number of trajectories 309. For example, a grid-world environment with 60 trajectory embeddings may have 10 trajectory clusters, whereas a gaming environment with 717 trajectory embeddings may have 8 trajectory clusters.

In some embodiments, the trajectory attribution system 106 identifies a target trajectory cluster. As used herein the term “target trajectory cluster” refers to a single trajectory cluster that the trajectory attribution system 106 identifies and removes from the set of trajectory clusters. In particular, the trajectory attribution system 106 removes the trajectory embeddings 314 associated with the target trajectory cluster from the collection of trajectory embeddings 314 making up the offline reinforcement learning data set (D).

As just mentioned, in one or more embodiments, the trajectory attribution system 106 utilizes a clustering algorithm to group the trajectory embeddings 310b into trajectory clusters 312a-312n. To generate the trajectory clusters, in some cases, the trajectory attribution system 106 utilizes the following algorithm (e.g., Algorithm 2):

Algorithm 2: clusterTrajectories

| | |
|---|---|
| /* Clustering the trajectories using their embeddings | */ |

| | |
|---|---|
| Input | : Trajectory embeddings T = {tᵢ}, clusteringAlgo |

1 C + clusteringAlgo(T) // Cluster using provided clustering algorithm

| | |
|---|---|
| Output | : Return trajectory clusters C = {cᵢ}ᵢ₌₁ⁿ^{_{c}} |

where T={tᵢ} represents the returned trajectory embeddings, C={cᵢ}ᵢ₌₁ⁿ^{_{c}} represents the trajectory clusters, and n_{c} represents the number of clusters. As mentioned above, the trajectory attribution system 106 utilizes the clustering algorithm to generate trajectory clusters 312a-312n. In particular embodiments, the trajectory attribution system 106 utilizes an X-Means clustering algorithm. In some cases, utilizing the X-Means clustering algorithm allows the trajectory attribution system 106 to automatically determine the number of trajectory clusters 312a-312n. Such implementations enable the trajectory attribution system 106 to identify all possible patterns in the trajectories 309 without forcing the number of clusters (n_{c}) as a hyperparameter. Alternatively, in some cases, the trajectory attribution system 106 utilizes any suitable clustering algorithm. For example, in certain implementations, the trajectory attribution system 106 utilizes a K-means clustering algorithm to generate the trajectory clusters 312a-312n.

As further shown in FIG. 3A, the trajectory attribution system 106 performs the act 306 of embedding trajectories. In particular, FIG. 3A shows the trajectory attribution system 106 generating a trajectory embedding 316. As used herein, the term “trajectory embedding” refers to a data embedding comprising trajectories in an offline training data set. For instance, the trajectory embedding can be a representation of the offline training data set comprising the collection of trajectories. As mentioned above, in some implementations, the trajectory attribution system 106 identifies the smallest set of trajectories (e.g., trajectory cluster), the absence of which from the offline training data set (D) leads to a different behavior of the reinforcement learning agent for the given state under consideration. Such implementations allow the trajectory attribution system 106 to attribute the behavior of the reinforcement learning agent to a specific trajectory cluster (e.g., target trajectory cluster).

As just mentioned, the trajectory attribution system 106 generates the trajectory embedding 316. In some embodiments, the trajectory attribution system 106 generates the trajectory embedding 316 by summing the individual trajectory embeddings 314. In some embodiments, the trajectory attribution system 106 normalizes the summed trajectory embeddings. In some embodiments, the trajectory attribution system 106 normalizes the summed trajectory embeddings 314 by dividing the summed trajectory embeddings 314 with a constant. Moreover, the trajectory attribution system 106 generates the trajectory embedding 316 by applying a non-linearity function to the summed and normalized trajectory embeddings. 314. In some embodiments, the linearity function is a softmax function. For instance, the trajectory attribution system 106 can generate the trajectory embedding 316 by applying the softmax function to the trajectory embeddings. In one or more cases, the trajectory attribution system 106 can generate the trajectory embedding 316 by utilizing a data embedding algorithm. In particular embodiments, the trajectory attribution system 106 utilizes a third algorithm (Algorithm 3) as described below:

Algorithm 3: generateDataEmbedding

| | |
|---|---|
| /* Generating data embedding or a given set of trajectories | */ |

Input : Trajectory embeddings T = {tᵢ}, Normalizing factor M,
Softmax temperature T_{soft}
$1 \overline{s} ← \frac{{\sum }_{i} {t}_{i}}{M} // Sum the trajectory embedding and normalize them$
$2 \overline{d} ← \{ {d}_{j} \vert {d}_{j} \frac{exp ( {s}_{j} / {T}_{soft} )}{{\sum }_{k} exp ( {s}_{k} / {T}_{soft} )} \} // Take softmax along feature dimension$
Output : Return the data embedding d̅

where M represents a normalization factor, T_{soft} represents a softmax temperature function, s̅ represents the sum of trajectory embeddings, and d̅ represents the data embedding. As shown above, in certain implementations, the trajectory attribution system 106 sums the trajectory embeddings 314. In one or more cases, the trajectory attribution system 106 normalizes the sum of the trajectory embeddings 314. For example, the trajectory attribution system 106 divides the summed trajectory embeddings with a constant. In one or more implementations, the trajectory attribution system 106 utilizes a different normalization technique (e.g., Z-score normalization). In certain embodiments, the trajectory attribution system 106 applies a non-linear function (e.g., softmax) over the feature dimension to generate the trajectory embedding 316.

In one or more cases, the trajectory attribution system 106 generates data embeddings for (n_{c})+1 of trajectory clusters cⱼ. In particular embodiments, the trajectory attribution system 106 generates a trajectory embedding (d̅_{orig}) representing the embedding of the all the trajectories in offline training data set (D) and complementary data embeddings (d̅ⱼ) corresponding to trajectory clusters cⱼ. In some implementations, the trajectory attribution system 106 generates the complementary data embedding by embedding a complementary data set associated with a specific trajectory cluster cⱼ.

As mentioned above, FIGS. 3A-3B show the trajectory attribution system 106 generating the cluster attribution for the target cluster in accordance with one or more embodiments. In particular, FIG. 3B illustrates the trajectory attribution system 106 training a test reinforcement learning agent, generating a complementary target data embedding, and generating a cluster attribution in accordance with one or more embodiments.

As mentioned above, the trajectory attribution system 106 trains the reinforcement learning agent on the offline reinforcement learning data set (D). As shown in FIG. 3B, the trajectory attribution system 106 performs the act 308 of training a test reinforcement learning agent. As used herein the term “test reinforcement learning agent” refers to an offline reinforcement learning agent trained on a complementary/test data set. For instance, in some embodiments, multiple test reinforcement learning agents train on a plurality of complementary target data sets. In some cases, the test reinforcement learning agent generates explanation policies 320a-320b that cause the test reinforcement learning agent to take actions that differ from the reinforcement learning agent. Relatedly, as used herein the term “complementary target data set” refers to a data set that includes all the trajectory embeddings from the offline reinforcement learning data set (D) except for the trajectory embeddings corresponding to the target trajectory cluster. In some cases, the trajectory attribution system 106 generates a plurality of complementary target data sets 318a-318b by removing target trajectory clusters for the plurality of complementary target data sets 318a-318b.

As just mentioned, the trajectory attribution system 106 trains the test reinforcement learning agent on the complementary target data set 318a. In one or more embodiments, the trajectory attribution system 106 trains test reinforcement learning agents on a plurality of complementary target data sets 318a-318b. In certain implementations, the trajectory attribution system 106 trains test reinforcement learning agents on each complimentary data set 318a-318b within the offline reinforcement learning data set. Thus, in some implementations, the trajectory attribution system 106 generates an explanation policy 302a (e.g., result) corresponding to each trajectory cluster 312a.

As mentioned above, in some cases, the trajectory attribution system 106 generates a complementary data embedding. More specifically, in certain implementations, the trajectory attribution system 106 computes complementary data embeddings for each complementary data set 318a-318b by utilizing a non-linear function. For example, in certain cases, the trajectory attribution system 106 generates a plurality of complementary data embeddings by gathering, normalizing, and applying the softmax function to the trajectory embeddings within the complementary data set 318a. In some instances, the trajectory attribution system 106 generates a plurality of complementary target data embeddings for complementary target data sets 318a-318b. As discussed in more detail below, in some embodiments the trajectory attribution system 106 generates the cluster attribution by generating the plurality of complementary target data embeddings.

In some embodiments, the trajectory attribution system 106 generates the result of the test reinforcement learning agent by utilizing an offline reinforcement learning algorithm. For example, in some cases, the trajectory attribution system 106 utilizes a model-based algorithm (e.g., predictive model). In certain implementations, the trajectory attribution system 106 utilizes a model-free algorithm (e.g., predictive free model). Moreover, in one or more embodiments, the trajectory attribution system 106 trains the reinforcement learning agent by utilizing a combination of model-free and model-based algorithms.

As shown in FIG. 3B, the trajectory attribution system 106 performs the act 308 of training a test reinforcement learning agent. In particular, for each trajectory cluster cⱼ the trajectory attribution system 106 trains the test reinforcement learning agent on the corresponding complementary data set. For example, the trajectory attribution system 106 trains the test reinforcement learning agent according to the following algorithm (e.g., Algorithm 4):

Algorithm 4: trainExpPolicies

/* Train explanation policies and compute corresponding data embeddings */

| | |
|---|---|
| Input | : Offline data{τᵢ}, Traj. Embeddings T, Traj. Clusters C, |

offlineRLAlgo
1 for cⱼ in C do

| | |
|---|---|
| 2 | {τⱼ}j ← {τᵢ} − cⱼ // Compute complementary dataset corresp. To cⱼ |
| 3 | Tⱼ ← gatherTrajectoryEmbeddings(T, {τᵢ}ⱼ) // Gather corresp. τ embeds |
| 4 | Explanation policy, Πⱼ ← offlineRLAlgo({Tᵢ}ⱼ) |
| 5 | Complementary data embedding, dj ← generateDataEmbedding |
| | (Tⱼ, M,T_{soft}) |
| Output | : Explanation policies {Πⱼ}, Complementary data embeddings {dⱼ} |

where {τᵢ} represents the trajectories in the offline data set, T represents the trajectory embeddings, C represents the trajectory clusters, cⱼ represents a specific trajectory cluster, {τⱼ}ⱼ represents the complementary data set corresponding to a specific cluster cⱼ, Tⱼ represents a corresponding trajectory embedding, offlineRLAlgo represents the offline reinforcement learning algorithm, M represents a normalization constant, T_{soft} represents the softmax temperature, πⱼ represents a complementary explanation policy, and {d̅ⱼ} represents complementary data embeddings.

As indicated above, the trajectory attribution system 106 generates the complementary data embeddings d̅ⱼ by embedding a complementary data set associated with the trajectory cluster cⱼ. For example, the trajectory attribution system 106 generates the complementary data set by removing the trajectories in the corresponding trajectory cluster from the offline training data set (D). In some implementations, the trajectory attribution system 106 constructs complementary data sets for the remaining n_{c} sets by removing the specified trajectory cluster cⱼ from the offline training data set (D). For example, the trajectory attribution system 106 generates a complementary target data set associated with the target trajectory cluster by removing a target trajectory cluster from the offline training data set (D). In particular embodiments, the trajectory attribution system 106 removes the embedded trajectories present in the target trajectory cluster from the embedded trajectories remaining in the offline training data set (D). In one or more embodiments, the trajectory attribution system 106 generates the complementary target data embeddings by utilizing Algorithm 4 on the complementary target data set.

As mentioned above, the trajectory attribution system 106 trains the reinforcement learning agent on the offline reinforcement learning data set (D) with the offline reinforcement learning algorithm (e.g., offlineRLAlgo). In some cases, the trajectory attribution system 106 trains the test reinforcement learning agent on the complementary data set using the same offline reinforcement learning algorithm. In particular implementations, the trajectory attribution system 106 ensures that all the training conditions (e.g., algorithm, weight initialization, optimizers, hyperparameters, random seeds etc.) for the test reinforcement learning agent are identical to the training conditions of the reinforcement learning agent, except for the modification in the training data (e.g., training on the complementary data embedding).

As shown in FIG. 3B and described in Algorithm 4, in some embodiments, the trajectory attribution system 106 generates an explanation policy (π₁) 320a corresponding to cluster (C₁) by training the test reinforcement learning agent on the complementary data set {τⱼ}₁ 318a. As shown in FIG. 3B, the trajectory attribution system 106 computes (n_{c}) explanation policies πⱼ. In particular, the trajectory attribution system 106 trains the explanation policies πₙ 320b based on the complementary datasets {τⱼ}ₙ 318b without the i′th cluster. Thus, in one or more embodiments, the trajectory attribution system 106 trains the test reinforcement learning agent on each complementary data set and generates the explanation policy associated with every trajectory cluster. As described in more detail below, in certain implementations, the trajectory attribution system 106 compares all of the test decision(s) with the original decision 208 As further shown in FIG. 3B, the trajectory attribution system 106 performs the act 310 of generating a cluster attribution. As used herein the term “cluster attribution” refers to attributing a behavior, action, and/or decision of the reinforcement learning agent to a trajectory cluster. For example, based on the differing actions of the reinforcement learning agent and the test reinforcement learning agent, the trajectory attribution system 106 can determine the effect of the missing trajectory cluster (e.g., target trajectory cluster) on the decision making of the reinforcement learning agent.

In one or more implementations, the trajectory attribution system 106 generates the cluster attribution by comparing the results (e.g., actions) of the test reinforcement learning agents with the result (e.g., action) of reinforcement learning agent for the given state. For example, the trajectory attribution system 106 notes all the results suggested by the test reinforcement learning agents trained on the complementary data sets 318a-318b and compares the results of the test reinforcement learning agents with the result of the reinforcement learning agent. In particular, in some embodiments, the trajectory attribution system 106 determines if the result of the test reinforcement learning agent differs from the result of the reinforcement learning agent and the degree to which the result of the test reinforcement learning agent differs from the result of the reinforcement learning agent.

As just mentioned, in some embodiments, the trajectory attribution system 106 computes and compares the differences between the result (e.g., action) suggested by the test reinforcement learning agent and the result (e.g., action) suggested by reinforcement learning agent over an action space. In some cases, the trajectory attribution system 106 computes the differences between the result suggested by the test reinforcement learning agent and the result suggested by the reinforcement learning agent computing an action distance over an action space (e.g., continuous, discrete, etc.). As used herein the term “action distance” refers to the distance between actions made by a reinforcement learning agent based on the policy that suggests an action. In some embodiments, the trajectory attribution system 106 determines the action distance by assuming a metric over the action space. In some embodiments, the trajectory attribution system 106 determines if the results (e.g., actions) of the test reinforcement learning agents correspond to a maximum distance from the result (e.g., action) of the reinforcement learning agent within the action space. In one or more implementations, based on the results of the test reinforcement learning agents having the maximum distance from the result of the reinforcement learning agent, the trajectory attribution system 106 generates a candidate attribution set.

In some embodiments, the candidate attribution set includes a plurality of complementary target data sets associated with the results of the test reinforcement learning agents with the maximum distances from the result of the reinforcement learning agent. For example, the candidate attribution set may include the plurality of complementary target data sets associated with results that exceed a threshold distance from the result of the reinforcement learning agent. In some embodiments, the candidate attribution set includes the complementary target data sets corresponding to results with the top three maximum distances from the result of the reinforcement learning agent.

As just mentioned, the trajectory attribution system 106 generates the candidate attribution sets by determining the distances between the results (e.g., actions, behaviors, etc.) of the test reinforcement learning agents and the result of the reinforcement learning agent. In one or more implementations, the trajectory attribution system 106 compares the distance between each complementary data embedding associated with each result within the candidate attribution set and the trajectory embedding comprising the entirety of the offline training data set. For example, the trajectory attribution system 106 determines the distances between the complementary data embeddings and the trajectory embedding by utilizing a Wasserstein metric. Based on the distances between the complementary data embeddings and the trajectory embedding, the trajectory attribution system 106 selects the result corresponding to the complementary data embedding with the smallest distance from the trajectory embedding. In one or more cases, the trajectory attribution system 106 generates the cluster attribution by selecting (e.g., crediting) the trajectory cluster corresponding to the complementary data embedding with the smallest distance from the trajectory embedding.

As just discussed, the trajectory attribution system 106 compares the results (e.g., actions, behaviors, explanation policies) of the reinforcement learning agent with the results of the test reinforcement learning agent for the given state. In some embodiments, the trajectory attribution system 106 determines the cluster attribution according to the following algorithm (e.g., Algorithm 5):

Algorithm 5: generateClusterAttribution

| | |
|---|---|
| /* Generating cluster attributions for a_{orig} = Π_{orig}(s) | */ |

| | Input | : State s, Original Policy Π_{orig}, Explanation Policies {Πⱼ}, Original |
|---|---|---|
| | Data Embedding d̅_{orig}, Complementary Data Embeddings {d̅ⱼ} | |
| 1 | Original action, a_{orig} ← Π_{orig}(s) | |
| 2 | Actions suggested by explanation policies, aⱼ ← Πⱼ(s) | |
| 3 | d_{aorig,aj} ← calcActionDistance (a_{orig}, aⱼ) // Compute action distance | |
| 4 | K ← argmax(daorig,aj) // Get candidate clusters using argmax | |
| 5 | wₖ ← W_{dist}(d̅_{orig}, d̅ₖ) // Compute Wasserstein distance b/w complementary | |
| | data embeddings of candidate clusters & orig data embedding | |
| 6 | c_{final} ← argmin(wₖ) // Choose cluster with min data embedding dist. | |
| | Output | : c_{final} |

where(s) represents the given state, π_{orig} represents the original explanation policy, d̅_{orig} represents the trajectory embedding, d̅ⱼ represents the complementary data embedding, d̅_{orig} represents the original action corresponding to the original explanation policy, it represents the complementary explanation policy, aⱼ represents the complementary action, dₐ_{_{orig}}_{.a}_{ⱼ} represents the action distance between the original action and the complementary action, K represents the candidate attribution set comprising one or more complementary data embeddings corresponding to trajectory clusters, wₖ represents the Wasserstein distance between the complementary data embedding and trajectory embedding, and c_{final} represents the cluster attribution.

In the above Algorithm 5, the argmax represents an operation that finds the trajectory clusters corresponding to complementary data embeddings that give the maximum value (e.g., distance) from the trajectory embedding d̅_{orig}. Additionally, as shown in Algorithm 5, W_{dist} represents the Wasserstein metric that captures distances between the non-linear function (e.g., softmax) simplices. Moreover, as included in Algorithm 5, argmin represents an operation that finds the smallest possible value (e.g., distance) between the complementary data embeddings d̅ₖ in the candidate attribution set K and the trajectory embedding d̅_{orig}. As shown above in Algorithm 5, the argmax represents an operation that finds the trajectory clusters corresponding to complementary data embeddings that give the maximum value (e.g., distance) from the single data embedding d̅_{orig}. Additionally, as shown in Algorithm 5, W_{dist} represents the Wasserstein metric that captures distances between softmax simplices. Moreover, as included in Algorithm 5, argmin represents an operation that finds the smallest possible value (e.g., distance) between the complementary data embeddings d̅ₖ in the candidate attribution set K and the trajectory embedding d̅_{orig}.

For instance, as shown in FIG. 3B and Algorithm 5, the trajectory attribution system 106 identifies the original policy π_{orig} (s, a) 322 of the reinforcement learning agent. In one or more embodiments, the trajectory attribution system 106 considers all the actions (e.g., explanation policies) at the given state generated by test reinforcement learning agent(s) and selects a policy that suggests a different action from the original policy 322. In particular, the trajectory attribution system 106 computes distances between the actions suggested by the test reinforcement learning agent and the action suggested by the reinforcement learning agent. In some embodiments, the trajectory attribution system 106 computes the distances by assuming a metric over an action space (e.g., discrete or continuous). For example, the trajectory attribution system 106 calculates the distance between the action suggested by the explanation policy of the test reinforcement learning agent based on the complementary target data set associated with the target trajectory cluster.

In some cases, the trajectory attribution system 106 generates a candidate attribution set comprising of one or more explanation policies from test reinforcement learning agent(s) that has a maximum distance from the original explanation policy of the reinforcement learning agent. In one or more implementations, for each explanation policy in the candidate attribution set, the trajectory attribution system 106 computes the distance between the respective complementary data embedding di and the data embedding d̅_{orig} of the entire offline training data set (D). In some embodiments, the trajectory attribution system 106 computes the distance between the complementary data embedding d̅ⱼ and the data embedding d̅_{orig} of the entire offline training data set (D) by utilizing the Wasserstein metric for capturing distance between softmax simplices as described in S.S. Vallender, Calculation of the Wasserstein Distance Between Probability Distributions on the Line, Theory of Probability & Its Applications, 18 (4): 784-786, 1974.

As shown in FIG. 3B, the trajectory attribution system 106 selects the explanation policy of the complementary data embedding d̅ⱼ that suggests a different action and has the smallest distance from the data embedding d̅_{orig} of the entire offline training data set (D). In some cases, based on the selection of the complementary data embedding with the smallest distance, the trajectory attribution system 106 attributes the decision of the reinforcement learning agent to trajectory cluster 312a corresponding to the explanation policy π₁ 302a.

As discussed above, the trajectory attribution system 106 calculates the cluster attribution by utilizing several algorithms. In one or more embodiments, the trajectory attribution system 106 combines the previously discussed algorithms into a single summarized algorithm (e.g., Algorithm 6) as shown below:

Algorithm 6: Trajectory Attribution in Offline RL

| | |
|---|---|
| Input | : Offline Data {Tᵢ}, States needing explanation Sₑₓₚ, Sequence |

Encoder E, offlineRLAlgo, clusteringAlgo, Normalizing constant M, Softₘₐₓ
Temperature T_{soft}

| | |
|---|---|
| /* Train original offline RL policy | */ |

1 Π_{orig} ← offlineRLAlgo({τᵢ})

| | |
|---|---|
| /* Encode individual trajectories | */ |

2 T = encodeTrajectories({τᵢ}), E) // Algo. 1

| | |
|---|---|
| /* Cluster the trajectories | */ |

3 C ← clusterTrajectories(T, clusteringAlgo) // Algo. 2

| | |
|---|---|
| /* Compute data embedding for the entire dataset | */ |

4 d̅_{orig} = generateDataEmbedding(T, M, T_{soft}) / Algo. 3
/* Generate explanation policies and their corresponding complementary data
embeddings*/
5 {Πⱼ}, {d̅ⱼ} ←trainExpPolicies({τᵢ}, T, C, offlineRLAlgo)// Algo. 4
/* Attributing policy decisions for given set of states
*/
6 for s ∈ Sₑₓₚ do

| | |
|---|---|
| 7 | c_{final←}generateClusterAttribution(s, Π_{orig}, {Πⱼ}, d̅_{orig}, d̅ⱼ) // Algo. 5 |
| 8 | *Optionally, select top N trajectories in the cluster c_{final} using a pre- |

defined criteria.

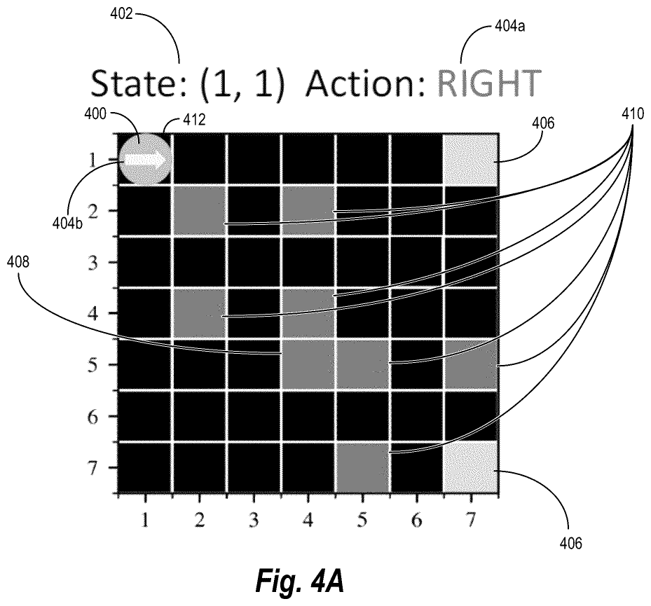

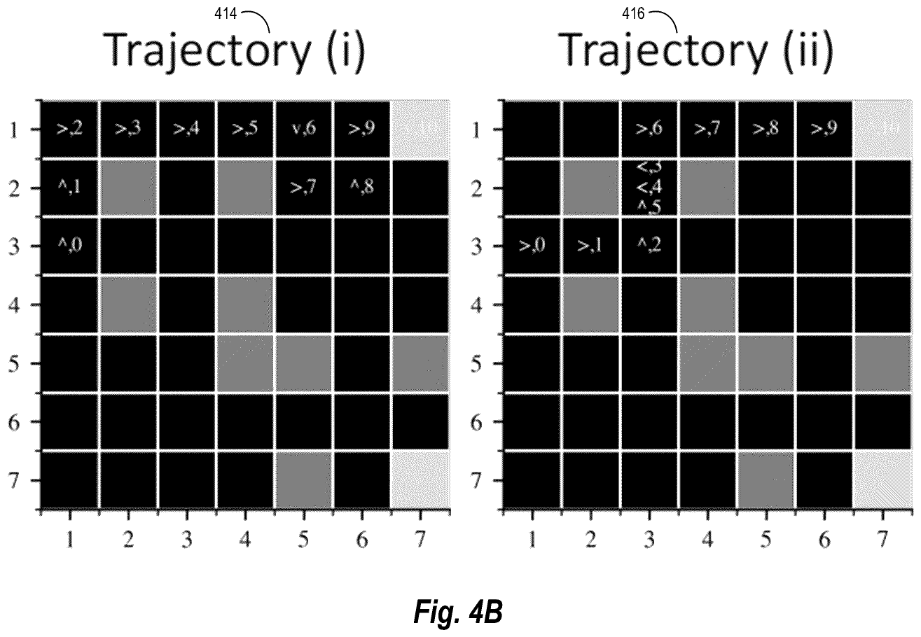

FIGS. 4A-4B illustrate an example of an offline reinforcement learning agent suggesting an action in a grid-world environment and the trajectory attribution system 106 attributing the action to a trajectory cluster in accordance with one or more embodiments. In particular, FIG. 4A shows the reinforcement learning agent achieving a goal by performing an action based on a given state. For example, in one or more cases, the goal of the reinforcement learning agent 400 at the given state 402 (e.g., (1,1)) is to reach any goal states 406 by avoiding a pitfall 408 while navigating around impenetrable walls 410. In particular embodiments, the reward for reaching the goal state is +1, the reward for falling into the pitfall 408 is −1, and for any other transitions, the offline reinforcement learning agent receives-0.1. As just mentioned, the reinforcement learning agent 400 navigates through the grid-world based on given state 402. In some implementations, the reinforcement learning agent navigates through the grid-world environment by performing an up, down, left, or right action.

As discussed above, the goal of the offline reinforcement learning agent in the grid-world environment is reaching either goal state 406 while avoiding a pitfall 408. FIG. 4B illustrates the trajectory attribution system 106 attributing the action of the reinforcement learning agent to a target trajectory cluster in accordance with one or more embodiments. For example, the trajectory attribution system 106 trains the reinforcement learning agent on an offline data set comprising 60 trajectories. In some embodiments, the trajectory attribution system 106 collects the offline data set from policy rollouts of other reinforcement learning agents. In other embodiments, the trajectory attribution system 106 collects trajectories from a previously trained RL agent. In alternative embodiments, the trajectory attribution system 106 collects trajectories from standardized environments (e.g., D4RL repository). Moreover, in certain cases, the trajectory attribution system 106 trains the sequence encoder. For example, the trajectory attribution system 106 trains a long-short term memory (“LSTM”) trajectory sequence encoder by replacing a trajectory transformer with LSTM. In some implementations, the trajectory attribution system 106 utilizes a pre-trained decision transformer as the sequence encoder.

As discussed above, the trajectory attribution system 106 trains the reinforcement learning agent on the offline data set by utilizing a model-based approach and embeds the entire offline training data set for the grid-world environment. According to the method described above, the trajectory attribution system 106 encodes the trajectories utilizing the sequence encoder and groups the output trajectory embeddings into trajectory clusters by utilizing the X-means algorithm. For instance, in one or more implementations, the trajectory attribution system 106 generates 10 trajectory clusters for the grid-world environment. Moreover, in accordance with the methods described above to the trajectory attribution system 106 obtains 10 complementary data sets based on the previously generated trajectory clusters. In some embodiments, the trajectory attribution system 106 trains the reinforcement learning agent with a soft-actor critic agent in discrete action settings. In one or more implementations, the trajectory attribution system 106 trains the reinforcement learning agent with a soft actor critic utilizing an offline deep reinforcement learning library (e.g., d3rlpy).

As discussed above, the trajectory attribution system 106 computes complementary data embeddings for each complementary data set. Moreover, as previously described, the trajectory attribution system 106 generates explanation policies on the 10 complementary data embeddings for the grid-world environment by inputting the complementary data embeddings into a test reinforcement learning agent. Moreover, the trajectory attribution system 106 attributes the action made by the reinforcement learning agent for a given state to the trajectory cluster. In particular, the trajectory attribution system 106 generates a cluster attribution by comparing the policy of the test reinforcement learning agent with the reinforcement learning agent.

As shown in FIG. 4B, the trajectory attribution system 106 selects the top two trajectories from the attributed cluster by matching the context for the state-action under consideration with trajectories in the trajectory cluster. As illustrated in FIG. 4B, trajectories distant from the cell under consideration 412 influence the action suggested by the reinforcement learning agent. In particular, trajectory (i) 414 that goes through cell (1,1) influences the decision of the reinforcement learning agent as well as trajectory (ii) 416 that is distant from cell (1,1). Thus, in certain implementations, a distance experience (e.g., trajectory (ii) 416) affects the actions of the reinforcement learning agent.

In one or more cases, it is important to relay relevant information about the decisions of complex AI models (e.g., reinforcement learning agents). Researchers conducted experiments that compared trajectories generated by an example implementation of the trajectory attribution system 106 with attributions selected by humans. In a study, ten participants with a complete understanding of the grid-world navigation environment analyzed the actions of the reinforcement learning agent. More specifically, the participants had two tasks where they needed to (i) choose a trajectory that they thought best explains the action suggested in the grid cell by the reinforcement learning agent and (ii) identify all relevant trajectories explaining the action suggested by the reinforcement learning agent. Moreover, the study identified human bias by including a randomly selected trajectory and a trajectory selected from a different trajectory cluster that did not attribute to the action of the reinforcement learning agent with the other trajectories included in the attributed trajectory cluster.

On average, across three studies for the first task, 70% of participants selected trajectories generated by the disclosed method as the best explanation for the action of the reinforcement learning agent. Moreover, while analyzing the second task for the grid-world environment at the given state 402 (e.g., (1,1)) with the suggested action 404a-404b (e.g., right) on average, nine out of the ten participants agreed with the trajectories (e.g., trajectory (i) 414 and trajectory (ii) 416) generated by the method described above. Relatedly, the following study demonstrates that the participants did not consider all trajectories generated by the disclosed method as relevant. Such a suggestion indicates that in some instances human participants have insufficient understanding of the factors influencing the decision-making of reinforcement learning agents. Thus, the explainability (e.g., interpretability) tools of the disclosed method become important in communicating the actions of reinforcement learning agents.

As just mentioned, explaining the actions of reinforcement agents (e.g., offline reinforcement agents), provides important information for analysis and knowledge of the behaviors of reinforcement learning agents. For instance, while the previously discussed example provides insight on the reinforcement learning agent in a grid-world environment, the present application has many uses in other contexts. For instance, the trajectory attribution system 106 can explain the actions of reinforcement learning agent in environments ranging from navigational tasks to complex continuous control tasks and visual input video games. For example, as mentioned above offline reinforcement learning agents include artificial intelligence chatbots (e.g., ChatGPT). Such systems generate human-like conversations, answer questions, compose essays, generate code, etc. by gathering information from a large variety of sources (e.g., scientific journals, news articles, books, etc.). However, due to the black box nature of these systems, it is difficult to identify factors influencing the output (e.g., answer, essay, etc.), action and/or behavior of artificial intelligence system.

In one or more embodiments, the trajectory attribution system 106 attributes trajectories (e.g., experiences, data, etc.) that influence the output of the artificial intelligence chatbot system. For example, particular artificial intelligence chatbot systems train on reinforcement learning algorithms. In such cases, the trajectory attribution system 106 identifies and attributes the data inputs (e.g., trajectory clusters) causing the artificial intelligence chatbot system to answer the question in a particular fashion by utilizing the disclosed method.

As just mentioned above, the trajectory attribution system 106 utilizes the above-described method in a variety of environments. In some embodiments, the trajectory attribution system 106 attributes the actions of the reinforcement learning agent in email campaign environments, video game environments with continuous visual observations, and 2D model environments. In each of the mentioned environments, the trajectory attribution system 106 generated cluster attributions with semantically meaningful high-level behaviors for the reinforcement learning agent. For example, analysis of the disclosed method indicates that the results of the reinforcement learning agent (e.g., original policy) in the above-mentioned environments outperforms the results (e.g., other policies) of the test reinforcement learning agent trained on the complementary data sets. In particular, the original policy having access to all behaviors, outperforms other policies that are trained on data lacking information about important behaviors (e.g., grid-world: reaching a goal space). Thus, the trajectory attribution system 106 perceives the explanation polices that suggest the most contrasting actions as low-return actions. Such evidence suggests the efficacy of the disclosed method by identifying trajectories (e.g., behaviors) which, when removed, make the reinforcement learning agent choose actions that are not originally considered suitable.

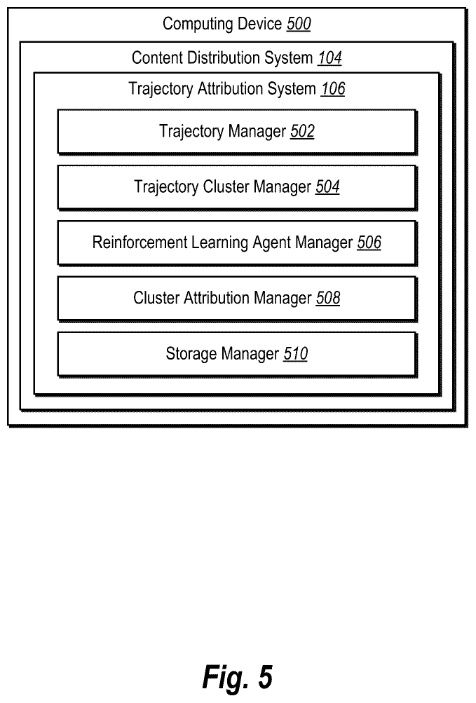

Looking now to FIG. 5, additional detail will be provided regarding components and capabilities of the trajectory attribution system 106. Specifically, FIG. 5 illustrates an example schematic diagram of the trajectory attribution system 106 on an example computing device 500 (e.g., one or more of the client device 112, the administrator device 110, the database 108 and/or the server(s) 102). In some embodiments, the computing device 500 refers to a distributed computing system where different managers are located on different devices, as described above. As shown in FIG. 5, the trajectory attribution system 106 includes a trajectory manager 502, a trajectory cluster manager 504, a reinforcement learning agent manager 506, a cluster attribution manager 508, and a storage manager 510.

As just mentioned, the trajectory attribution system 106 includes a trajectory manager 502. In particular, the trajectory manager 502 manages, maintains, gathers, determines, or identifies trajectories associated with an environment. For example, the trajectory manager 502 gathers an offline reinforcement learning data set from an environment at a given state to train the offline reinforcement learning agent.

As shown, the trajectory attribution system 106 also includes a trajectory cluster manager 504. In particular, the trajectory cluster manager 504 manages, maintains, stores, access, provides, determines, or generates trajectory clusters associated with the offline training data set. For example, the trajectory cluster manager 504 determines the number of trajectory clusters from the set of trajectories in the offline training data set. In some cases, the trajectory cluster manager 504 further determines which trajectories to group together into a trajectory cluster. The trajectory cluster manager 504 further stores the clustering algorithm and applies the clustering algorithm to the trajectories in the offline training data set.

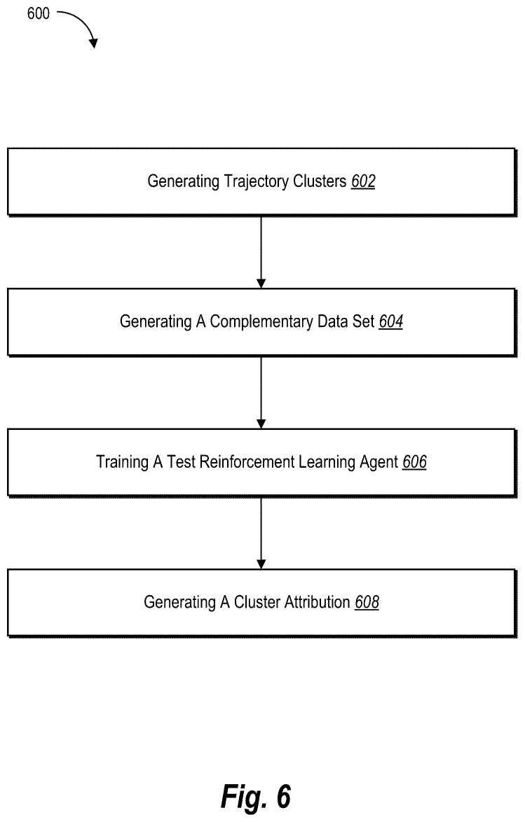

As further illustrated in FIG. 6, the trajectory attribution system 106 includes a reinforcement learning agent manager 506. In particular, the reinforcement learning agent manager 506 manages, maintains, updates, determines, trains, modifies, tunes, adjusts, or recalibrates offline reinforcement learning agents. In some cases, the reinforcement learning agent manager 506 also manages the test reinforcement learning agents. For example, the reinforcement learning agent manager 506 identifies the parameters, weights, optimizers, etc. and trains the test reinforcement learning agent with the same parameters as the reinforcement learning agent.

Additionally, the trajectory attribution system 106 includes a cluster attribution manager 508. In particular, the cluster attribution manager 508 manages, determines, generates, predicts, or identifies a cluster attribution to a target cluster based on comparing explanation policies between complementary data sets. For example, the cluster attribution manager 508 generates the cluster attribution by comparing distances between the results (e.g., explanation policies) of the test reinforcement learning agents trained on the complementary data embeddings with the trajectory embedding. Moreover, the cluster attribution manager 508 stores cluster attributions for each trajectory cluster.

The trajectory attribution system 106 further includes a storage manager 510. The storage manager 510 operates in conjunction with, or includes, one or more memory devices such as the database 108 that store various data such as reinforcement learning agent parameters, offline training data sets, content distribution data, analytics metrics, and content data for distribution.

In one or more embodiments, each of the components of the trajectory attribution system 106 are in communication with one another using any suitable communication technologies. Additionally, the components of the trajectory attribution system 106 is in communication with one or more other devices including one or more client devices described above. It will be recognized that although the components of the trajectory attribution system 106 are shown to be separate in FIG. 5, any of the subcomponents may be combined into fewer components, such as into a single component, or divided into more components as may serve a particular implementation. Furthermore, although the components of FIG. 5 are described in connection with the trajectory attribution system 106, at least some of the components for performing operations in conjunction with the trajectory attribution system 106 described herein may be implemented on other devices within the environment.

The components of the trajectory attribution system 106, in one or more implementations, includes software, hardware, or both. For example, the components of the trajectory attribution system 106 include one or more instructions stored on a computer-readable storage medium and executable by processors of one or more computing devices (e.g., the computing device 500). When executed by the one or more processors, the computer-executable instructions of the trajectory attribution system 106 cause the computing device 500 to perform the methods described herein. Alternatively, the components of the trajectory attribution system 106 comprises hardware, such as a special purpose processing device to perform a certain function or group of functions. Additionally, or alternatively, the components of the trajectory attribution system 106 includes a combination of computer-executable instructions and hardware.

Furthermore, the components of the trajectory attribution system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the trajectory attribution system 106 may be implemented as part of a stand-alone application on a personal computing device or a mobile device. Alternatively, or additionally, the components of the trajectory attribution system 106 may be implemented in any application that allows creation and delivery of marketing content to users, including, but not limited to, applications in ADOBE® EXPERIENCE MANAGER and ADVERTISING CLOUD®, such as ADOBE ANALYTICS®, ADOBE JOURNEY OPTIMIZER, ADOBE AUDIENCE MANAGER®, and MARKETOR. “ADOBE,” “ADOBE EXPERIENCE MANAGER,” “ADVERTISING CLOUD,” “ADOBE ANALYTICS,” “ADOBE AUDIENCE MANAGER,” and “MARKETO” are either registered trademarks or trademarks of Adobe Inc. in the United States and/or other countries.

FIGS. 1-5 the corresponding text, and the examples provide a number of different systems, methods, and non-transitory computer readable media for generating cluster attributions for trajectories. In addition to the foregoing, embodiments can also be described in terms of flowcharts comprising acts for accomplishing a particular result. For example, FIG. 6 illustrates a flowchart of an example sequences or series of acts in accordance with one or more embodiments.

While FIG. 6 illustrates acts according to particular embodiments, alternative embodiments may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further embodiments, a system can perform the acts of FIG. 6. Additionally, the acts described herein may be repeated or performed in parallel with one another or in parallel with different instances of the same or other similar acts.

FIG. 6 illustrates an example series of acts 600 for generating cluster attributions for trajectories. In particular, the series of acts 600 includes an act 602 of generating trajectory clusters. In particular, the act 602 of generating trajectory clusters includes generating, utilizing a clustering algorithm, trajectory clusters from trajectories utilized to train a reinforcement learning agent. In some cases, the act 602 of generating trajectory clusters comprises determining, utilizing a clustering algorithm, trajectory clusters from the plurality of clusters. In some embodiments, the series of acts includes generating a reinforcement learning decision utilizing a reinforcement learning agent trained from a plurality of trajectories.

As shown, the series of acts 600 includes an act 604 of generating a complementary data set. In particular, an act 604 includes an act of generating a complementary target data set by removing a target trajectory cluster from the trajectory clusters. In one or more implementations, the act 604 includes generating a plurality of complementary target data sets by individually removing target trajectory clusters for the plurality of complementary target data sets.

In addition, the series of acts 600 includes an act 606 of training a test reinforcement learning agent. In particular, the act 606 involves training a test reinforcement learning agent utilizing the complementary target data set. In some embodiments, the act 606 includes training test reinforcement learning agents utilizing the plurality of complementary target data sets.

Further, the series of acts 600 includes an act 608 of generating a cluster attribution. In particular, the act 608 involves generating a cluster attribution for the reinforcement learning agent by comparing a result of the test reinforcement learning agent and a result of the reinforcement learning agent. In certain implementations, the act 608 includes generating a cluster attribution for the reinforcement learning agent by comparing reinforcement learning decisions of the test reinforcement learning agents with the reinforcement learning decision of the reinforcement learning agent.

In some embodiments, the series of acts 600 includes generating a plurality of complementary target data sets by individually removing target trajectory clusters for the plurality of complementary target data sets; and training test reinforcement learning agents utilizing the plurality of complementary target data sets. In one or more embodiments, the series of acts 600 includes determining distances within a feature space between the plurality of complementary target data sets and the trajectories utilized to train the reinforcement learning agent; and selecting the cluster attribution based on the distances.

In certain embodiments, the series of acts 600 involves generating, utilizing a non-linear function, a plurality of complementary target data embeddings from the plurality of complementary target data sets; generating, utilizing the non-linear function, a trajectory embedding from the trajectories utilized to train the reinforcement learning agent; and determining the distances between the plurality of complementary target data embeddings and the trajectory embedding.

In some cases, the series of acts 600 includes an act where generating the cluster attribution for the reinforcement learning agent comprises comparing reinforcement learning decisions of the test reinforcement learning agents with a reinforcement learning decision of the reinforcement learning agent.

In one or more cases, the series of acts 600 includes an act where comparing the reinforcement learning decisions of the test reinforcement learning agents with the reinforcement learning decision of the reinforcement learning agent further comprises, determining action distances between the reinforcement learning decisions of the test reinforcement learning agents and the reinforcement learning decision of the reinforcement learning agent; and selecting the cluster attribution by comparing the action distances. In some embodiments, the series of acts 600 includes an act of determining the trajectories by identifying for a first trajectory an observed state of a computing device, an action corresponding to the observed state, and a reward upon pursuing the action.

In certain embodiments, the series of acts 600 includes an act of generating, utilizing a sequence encoder, trajectory representations by encoding the trajectories utilized to train the reinforcement learning agent. In some cases, the series of acts 600 includes an act where generating the trajectory clusters comprises utilizing a clustering algorithm to generate the trajectory clusters from trajectory representations.

In one or more embodiments, the series of acts 600 includes an act where comparing the reinforcement learning decisions of the test reinforcement learning agents with the reinforcement learning decision of the reinforcement learning agent comprises: determining action distances within a feature space between the reinforcement learning decision of the test reinforcement learning agents and the reinforcement learning decision of the reinforcement learning agent; and comparing the action distances to select a trajectory cluster for the cluster attribution. In some cases, the series of acts 600 includes an act where the operations further comprise: generating complementary target embeddings from the plurality of complementary target data sets; and generating a trajectory embedding from the plurality of trajectories utilized to train the reinforcement learning agent. In certain embodiments, the series of acts 600 includes an act where generating the cluster attribution for the reinforcement learning agent further comprises comparing the complementary target embeddings and the trajectory embedding.

In one or more embodiments, the series of acts 600 includes an act where the operations further comprise determining a trajectory from the plurality of trajectories by receiving an observed state of a computing device, an action corresponding to the observed state, and a reward upon pursuing the action. In one or more embodiments, the series of acts 600 includes an act where the operations further comprise generating a plurality of complementary target data sets by individually removing target trajectory clusters for the plurality of complementary target data sets.

In one or more embodiments, the series of acts 600 includes an act where the operations further comprise: training test reinforcement learning agents utilizing the plurality of complementary target data sets; and generating the cluster attribution for the reinforcement learning agent by comparing a plurality of results of the test reinforcement learning agents and the result of the reinforcement learning agent. In certain embodiments, the series of acts 600 includes an act of determining distances within a feature space between the complementary target data sets and the trajectories utilized to train the reinforcement learning agent.

In one or more embodiments, the series of acts 600 includes an act of generating, utilizing a non-linear function, complementary target data embeddings from the complementary target data sets; and generating, utilizing the non-linear function, a trajectory embedding from the trajectories utilized to train the reinforcement learning agent.

In some embodiments, the series of acts 600 includes an act where comparing the result of the test reinforcement learning agent and the result of the reinforcement learning agent comprises comparing the distances to select a trajectory cluster for the cluster attribution.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an example computing device 700 (e.g., the computing device 700, the client device 112, the database 108, the administrator device 110 and/or the server(s) 102) that may be configured to perform one or more of the processes described above. One will appreciate that the trajectory attribution system 106 can comprise implementations of the computing device 700. As shown by FIG. 7, the computing device can comprise a processor(s) 702, memory 704, a storage device 706, an I/O interface 708, and a communication interface 710. Furthermore, the computing device 700 can include an input device such as a touchscreen, mouse, keyboard, etc. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 706 and decode and execute them.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 704 may be internal or distributed memory.

The computing device 700 includes a storage device 706 includes storage for storing data or instructions. As an example, and not by way of limitation, storage device 706 can comprise a non-transitory storage medium described above. The storage device 706 may include a hard disk drive (HDD), flash memory, a Universal Serial Bus (USB) drive or a combination of these or other storage devices.

The computing device 700 also includes one or more input or output (“I/O”) devices/interfaces 708, which are provided to allow a user to provide input to (such as user strokes), receive output from, and otherwise transfer data to and from the computing device 700. These I/O devices/interfaces 708 may include a mouse, keypad or a keyboard, a touch screen, camera, optical scanner, network interface, modem, other known I/O devices or a combination of such I/O devices/interfaces 708. The touch screen may be activated with a writing device or a finger.

The I/O devices/interfaces 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, devices/interfaces 708 is configured to provide graphical data to a display for presentation to a user. The graphical data may be representative of one or more graphical user interfaces and/or any other graphical content as may serve a particular implementation.

The computing device 700 can further include a communication interface 710. The communication interface 710 can include hardware, software, or both. The communication interface 710 can provide one or more interfaces for communication (such as, for example, packet-based communication) between the computing device and one or more other computing devices 700 or one or more networks. As an example, and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

1. A method comprising:
generating, utilizing a clustering algorithm, trajectory clusters from trajectories utilized to train a reinforcement learning agent;
generating a complementary target data set by removing a target trajectory cluster from the trajectory clusters;
training a test reinforcement learning agent utilizing the complementary target data set; and
generating a cluster attribution for the reinforcement learning agent by comparing a result of the test reinforcement learning agent and a result of the reinforcement learning agent.

2. The method of claim 1, further comprising:
generating a plurality of complementary target data sets by individually removing target trajectory clusters for the plurality of complementary target data sets; and
training test reinforcement learning agents utilizing the plurality of complementary target data sets.

3. The method of claim 2, further comprising:
determining distances within a feature space between the plurality of complementary target data sets and the trajectories utilized to train the reinforcement learning agent; and
selecting the cluster attribution based on the distances.

4. The method of claim 3, further comprising determining the distances within the feature space by:
generating, utilizing a non-linear function, a plurality of complementary target data embeddings from the plurality of complementary target data sets;
generating, utilizing the non-linear function, a trajectory embedding from the trajectories utilized to train the reinforcement learning agent; and
determining the distances between the plurality of complementary target data embeddings and the trajectory embedding.

5. The method of claim 2, wherein generating the cluster attribution for the reinforcement learning agent comprises comparing reinforcement learning decisions of the test reinforcement learning agents with a reinforcement learning decision of the reinforcement learning agent.

6. The method of claim 5, wherein comparing the reinforcement learning decisions of the test reinforcement learning agents with the reinforcement learning decision of the reinforcement learning agent further comprises:
determining action distances between the reinforcement learning decisions of the test reinforcement learning agents and the reinforcement learning decision of the reinforcement learning agent; and
selecting the cluster attribution by comparing the action distances.

7. The method of claim 1, further comprising:
determining the trajectories by identifying for a first trajectory an observed state of a computing device, an action corresponding to the observed state, and a reward upon pursuing the action.

8. The method of claim 1, further comprising:
generating, utilizing a sequence encoder, trajectory representations by encoding the trajectories utilized to train the reinforcement learning agent.

9. The method of claim 1, wherein generating the trajectory clusters comprises utilizing a clustering algorithm to generate the trajectory clusters from trajectory representations.

10. A system comprising:
a memory component; and
one or more processing devices coupled to the memory component, the one or more processing devices to perform operations comprising:
generating a reinforcement learning decision utilizing a reinforcement learning agent trained from a plurality of trajectories;
determining, utilizing a clustering algorithm, trajectory clusters from the plurality of trajectories;
generating a plurality of complementary target data sets by individually removing target trajectory clusters for the plurality of complementary target data sets;
training test reinforcement learning agents utilizing the plurality of complementary target data sets; and
generating a cluster attribution for the reinforcement learning agent by comparing reinforcement learning decisions of the test reinforcement learning agents with the reinforcement learning decision of the reinforcement learning agent.

11. The system of claim 10, wherein comparing the reinforcement learning decisions of the test reinforcement learning agents with the reinforcement learning decision of the reinforcement learning agent comprises:
determining action distances within a feature space between the reinforcement learning decision of the test reinforcement learning agents and the reinforcement learning decision of the reinforcement learning agent; and
comparing the action distances to select a trajectory cluster for the cluster attribution.

12. The system of claim 10, wherein the operations further comprise:
generating complementary target embeddings from the plurality of complementary target data sets; and
generating a trajectory embedding from the plurality of trajectories utilized to train the reinforcement learning agent.

13. The system of claim 12, wherein generating the cluster attribution for the reinforcement learning agent further comprises comparing the complementary target embeddings and the trajectory embedding.

14. The system of claim 10, wherein the operations further comprise determining a trajectory from the plurality of trajectories by receiving an observed state of a computing device, an action corresponding to the observed state, and a reward upon pursuing the action.

15. A non-transitory computer readable medium storing executable instructions which, when executed by a processing device, cause the processing device to perform operations comprising:
generating, utilizing a clustering algorithm, trajectory clusters from trajectories utilized to train a reinforcement learning agent;
generating a complementary target data set by removing a target trajectory cluster from the trajectory clusters;
training a test reinforcement learning agent utilizing the complementary target data set; and
generating a cluster attribution for the reinforcement learning agent by comparing a result of the test reinforcement learning agent and a result of the reinforcement learning agent.

16. The non-transitory computer readable medium of claim 15, wherein the operations further comprise generating a plurality of complementary target data sets by individually removing target trajectory clusters for the plurality of complementary target data sets.

17. The non-transitory computer readable medium of claim 16, wherein the operations further comprise:
training test reinforcement learning agents utilizing the plurality of complementary target data sets; and
generating the cluster attribution for the reinforcement learning agent by comparing a plurality of results of the test reinforcement learning agents and the result of the reinforcement learning agent.

18. The non-transitory computer readable medium of claim 17, further comprising determining distances within a feature space between the complementary target data sets and the trajectories utilized to train the reinforcement learning agent.

19. The non-transitory computer readable medium of claim 18, further comprising determining the distances within the feature space by:
generating, utilizing a non-linear function, complementary target data embeddings from the complementary target data sets; and
generating, utilizing the non-linear function, a trajectory embedding from the trajectories utilized to train the reinforcement learning agent.

20. The non-transitory computer readable medium of claim 18, wherein comparing the result of the test reinforcement learning agent and the result of the reinforcement learning agent comprises comparing the distances to select a trajectory cluster for the cluster attribution.
